(19) United States
(12) Patent Application Publication
(10) Pub. No.: US 2025/0384343 A1
(43) Pub. Date: Dec. 18, 2025

(54) System, Method, and Computer Program Product for Multi-Head Posterior Based Pre-Trained Model Evaluation

(71) Applicant: Visa International Service Association, San Francisco, CA (US)

(72) Inventors: Yan Zheng, Los Gatos, CA (US); Wei Zhang, Fremont, CA (US); Prince Osei Aboagye, Salt Lake City, UT (US); Junpeng Wang, Santa Clara, CA (US); Uday Singh Saini, San Mateo, CA (US); Xin Dai, Fremont, CA (US); Michael Yeh, Newark, CA (US); Yujie Fan, Cleveland Heights, OH (US); Zhongfang Zhuang, San Jose, CA (US); Shubham Jain, San Mateo, CA (US); Liang Wang, San Jose, CA (US)

(21) Appl. No.: 19/235,699

(22) Filed: Jun. 12, 2025

Related U.S. Application Data
(60) Provisional application No. 63/658,889, filed on Jun. 12, 2024.

(51) Int. Cl. G06N 20/00; G06F 17/18

(52) U.S. Cl. CPC G06N 20/00; G06F 17/18; G06F 2101/10

(57) ABSTRACT

Systems, methods, and computer program products for multi-head posterior based pre-trained model evaluation are provided. The system includes at least one processor configured to: generate an embedding dataset based on a pre-trained model, the embedding dataset including a plurality of embeddings representing a plurality of entities; cluster each entity of the plurality of entities based on a feature dataset, resulting in a plurality of clusters; and generate a metric for the pre-trained model based on a posterior probability of each entity of the plurality of entities and the plurality of clusters.

The present application claims the benefit of U.S. Provisional Patent Application No. 63/658,889, filed on Jun. 12, 2024, the disclosure of which is hereby incorporated by reference in its entirety.

### BACKGROUND

### 1. Technical Field

This disclosure relates generally to vision-language pre-trained models, model evaluation and, in non-limiting embodiments or aspects, to systems, methods, and computer program products for a multi-head posterior based approach for pre-trained model evaluation.

### 2. Technical Considerations

The embedding space is complex and challenging to interpret or explain. Despite extensive efforts to decipher it, the intricacies of the embedding space go beyond mere linear interpretability as some research suggests.

Pre-training on large models is becoming increasingly common in various machine learning applications, thanks to the growing amount of user-generated content. This is evident in areas such as Natural Language Processing (NLP) with models like Generative Pretrained Transformer (GPT). Typically, the effectiveness of these models is evaluated using downstream tasks. However, evaluating models with downstream tasks can be resource intensive and use a large number of computational resources if all tasks need to be performed.

### SUMMARY

According to non-limiting embodiments or aspects, provided is a system comprising: at least one processor configured to: generate an embedding dataset based on a pre-trained model, the embedding dataset comprising a plurality of embeddings representing a plurality of entities; cluster each entity of the plurality of entities based on a feature dataset, resulting in a plurality of clusters; and generate a metric for the pre-trained model based on a posterior probability of each entity of the plurality of entities and the plurality of clusters.

In non-limiting embodiments or aspects, the at least one processor is further configured to: generate a second embedding dataset based on a second pre-trained model, the second embedding dataset comprising a second plurality of embeddings representing the plurality of entities; cluster each entity of the plurality of entities based on a second feature dataset, resulting in a second plurality of clusters; and determine a metric for the second pre-trained model based on the posterior probability of each embedding of the second plurality of embeddings for the second plurality of clusters. In non-limiting embodiments or aspects, the at least one processor is further configured to: convert non-binary categorical features of the feature dataset into binary features, resulting in a binary tree comprising a binary feature dataset; and evaluate each of the features in the binary feature dataset based on splitting features until a number of entities per node of a binary tree node is no longer satisfied. In non-limiting embodiments or aspects, the at least one processor is further configured to: compute a first set of splitting features with a Maximum A Posteriori (MAP) for a first pre-trained model. In non-limiting embodiments or aspects, the at least one processor is further configured to: convert non-binary categorical features of the second feature dataset into binary features, resulting in a second binary feature dataset in a form of a binary tree; and evaluate each of the features in the resulting second binary feature dataset based on splitting features until a number of entities per tree node is no longer satisfied. In non-limiting embodiments or aspects, the at least one processor is further configured to: compute a second set of splitting features with a MAP for the second pre-trained model. In non-limiting embodiments or aspects, the at least one processor is further configured to: split a first binary feature dataset into multiple heads based on a random selection of dimensions from the first feature dataset to create a multi-head solution; determine a posterior probability of each point in each cluster included in each of the heads of the multi-head solution; evaluate the logarithm of each calculated posterior probability for each head and computing the average of all calculated logarithms as an average log posterior (ALP); and evaluate the ALP of each head. In non-limiting embodiments or aspects, the at least one processor is further configured to: split a second clustered binary feature dataset into multiple heads based on a random selection of dimensions from existing dimensions of the second feature dataset to create a multi-head solution; determine the posterior probability of each point in each cluster included in each of the heads of a second generated multi-head solution; evaluate a logarithm of each calculated posterior probability for each head and computing an average of all calculated logarithms as an ALP; and evaluate the ALP of each head. In non-limiting embodiments or aspects, the at least one processor is further configured to: compare two embedding datasets based on their respective average of all calculated logarithms from each head of their respective multi-head solutions and splitting criteria of each embedding dataset, resulting in two quality metrics per embedding dataset. In non-limiting embodiments or aspects, the at least one processor is further configured to: select a model from at least the pre-trained model and the second pre-trained model based on comparing the metric for the pre-trained model to the metric for the second pre-trained model.

According to non-limiting embodiments or aspects, provided is a method comprising: generating an embedding dataset based on a pre-trained model, the embedding dataset comprising a plurality of embeddings representing a plurality of entities; clustering each entity of the plurality of entities based on a feature dataset, resulting in a plurality of clusters; and generating a metric for the pre-trained model based on a posterior probability of each entity of the plurality of entities and the plurality of clusters.

In non-limiting embodiments or aspects, the method includes: generating a second embedding dataset based on a second pre-trained model, the second embedding dataset comprising a second plurality of embeddings representing the plurality of entities; clustering each entity of the plurality of entities based on a second feature dataset, resulting in a second plurality of clusters; and determining a metric for the second pre-trained model based on the posterior probability of each embedding of the second plurality of embeddings for the second plurality of clusters. In non-limiting embodiments or aspects, the method includes: converting non-binary categorical features of the feature dataset into binary features, resulting in a binary tree comprising a binary feature dataset; and evaluating each of the features in the binary feature dataset based on splitting features until a number of entities per node of a binary tree node is no longer satisfied. In non-limiting embodiments or aspects, the method includes: computing a first set of splitting features with a Maximum A Posteriori (MAP) for a first pre-trained model. In non-limiting embodiments or aspects, the method includes: converting non-binary categorical features of the second feature dataset into binary features, resulting in a second binary feature dataset in a form of a binary tree; and evaluating each of the features in the resulting second binary feature dataset based on splitting features until a number of entities per tree node is no longer satisfied. In non-limiting embodiments or aspects, the method includes: computing a second set of splitting features with a MAP for the second pre-trained model. In non-limiting embodiments or aspects, further comprising: splitting a first binary feature dataset into multiple heads based on a random selection of dimensions from a first feature dataset to create a multi-head solution; determining a posterior probability of each point in each cluster included in each of the heads of the multi-head solution; evaluating a logarithm of each calculated posterior probability for each head and computing an average of all calculated logarithms as an average log posterior (ALP); and evaluating the ALP of each head. In non-limiting embodiments or aspects, further comprising: splitting a second clustered binary feature dataset into multiple heads based on a random selection of dimensions from existing dimensions of the second feature dataset to create a multi-head solution; determining the posterior probability of each point in each cluster included in each of the heads of a second generated multi-head solution; evaluating a logarithm of each calculated posterior probability for each head and computing the average of all calculated logarithms as an ALP; and evaluating the ALP of each head. In non-limiting embodiments or aspects, the method includes: comparing the two embedding datasets based on their respective average log posterior from each head of their respective multi-head solutions and splitting criteria of each embedding dataset, resulting in two quality metrics per embedding dataset. In non-limiting embodiments or aspects, the method includes: selecting a model from at least the pre-trained model and the second pre-trained model based on comparing the metric for the pre-trained model to the metric for the second pre-trained model.

According to non-limiting embodiments or aspects, provided is a computer program product comprising at least one non-transitory computer-readable medium including instructions that, when executed by at least one processor, cause the at least one processor to perform the method of any of the preceding claims.

Further non-limiting embodiments or aspects are set forth in the following numbered clauses:

Clause 1: A system comprising: at least one processor configured to: generate an embedding dataset based on a pre-trained model, the embedding dataset comprising a plurality of embeddings representing a plurality of entities; cluster each entity of the plurality of entities based on a feature dataset, resulting in a plurality of clusters; and generate a metric for the pre-trained model based on a posterior probability of each entity of the plurality of entities and the plurality of clusters.

Clause 2: The system of clause 1, wherein the at least one processor is further configured to: generate a second embedding dataset based on a second pre-trained model, the second embedding dataset comprising a second plurality of embeddings representing the plurality of entities; cluster each entity of the plurality of entities based on a second feature dataset, resulting in a second plurality of clusters; and determine a metric for the second pre-trained model based on the posterior probability of each embedding of the second plurality of embeddings for the second plurality of clusters.

Clause 3: The system of clause 1 or 2, wherein the at least one processor is further configured to: convert non-binary categorical features of the feature dataset into binary features, resulting in a binary tree comprising a binary feature dataset; and evaluate each of the features in the binary feature dataset based on splitting features until a number of entities per node of a binary tree node is no longer satisfied.

Clause 4: The system of any of clauses 1-3, wherein the at least one processor is further configured to: compute a first set of splitting features with a Maximum A Posteriori (MAP) for a first pre-trained model.

Clause 5: The system of any of clauses 1-4, wherein the at least one processor is further configured to: convert non-binary categorical features of the second feature dataset into binary features, resulting in a second binary feature dataset in a form of a binary tree; and evaluate each of the features in the resulting second binary feature dataset based on splitting features until a number of entities per tree node is no longer satisfied.

Clause 6: The system of any of clauses 1-5, wherein the at least one processor is further configured to: compute a second set of splitting features with a MAP for the second pre-trained model.

Clause 7: The system of any of clauses 1-6, wherein the at least one processor is further configured to: split a first binary feature dataset into multiple heads based on a random selection of dimensions from the first feature dataset to create a multi-head solution; determine a posterior probability of each point in each cluster included in each of the heads of the multi-head solution; evaluate the logarithm of each calculated posterior probability for each head and computing the average of all calculated logarithms as an average log posterior (ALP); and evaluate the ALP of each head.

Clause 8: The system of any of clauses 1-7, wherein the at least one processor is further configured to: split a second clustered binary feature dataset into multiple heads based on a random selection of dimensions from existing dimensions of the second feature dataset to create a multi-head solution; determine the posterior probability of each point in each cluster included in each of the heads of a second generated multi-head solution; evaluate a logarithm of each calculated posterior probability for each head and computing an average of all calculated logarithms as an ALP; and evaluate the ALP of each head.

Clause 9: The system of any of clauses 1-8, wherein the at least one processor is further configured to: compare two embedding datasets based on their respective average of all calculated logarithms from each head of their respective multi-head solutions and splitting criteria of each embedding dataset, resulting in two quality metrics per embedding dataset.

Clause 10: The system of any of clauses 1-9, wherein the at least one processor is further configured to: select a model from at least the pre-trained model and the second pre-trained model based on comparing the metric for the pre-trained model to the metric for the second pre-trained model.

Clause 11: A method comprising: generating an embedding dataset based on a pre-trained model, the embedding dataset comprising a plurality of embeddings representing a plurality of entities; clustering each entity of the plurality of entities based on a feature dataset, resulting in a plurality of clusters; and generating a metric for the pre-trained model based on a posterior probability of each entity of the plurality of entities and the plurality of clusters.

Clause 12: The method of clause 11, further comprising: generating a second embedding dataset based on a second pre-trained model, the second embedding dataset comprising a second plurality of embeddings representing the plurality of entities; clustering each entity of the plurality of entities based on a second feature dataset, resulting in a second plurality of clusters; and determining a metric for the second pre-trained model based on the posterior probability of each embedding of the second plurality of embeddings for the second plurality of clusters.

Clause 13: The method of clause 11 or 12, further comprising: converting non-binary categorical features of the feature dataset into binary features, resulting in a binary tree comprising a binary feature dataset; and evaluating each of the features in the binary feature dataset based on splitting features until a number of entities per node of a binary tree node is no longer satisfied.

Clause 14: The method of any of clauses 11-13, further comprising: computing a first set of splitting features with a Maximum A Posteriori (MAP) for a first pre-trained model.

Clause 15: The method of any of clauses 11-14, further comprising: converting non-binary categorical features of the second feature dataset into binary features, resulting in a second binary feature dataset in a form of a binary tree; and evaluating each of the features in the resulting second binary feature dataset based on splitting features until a number of entities per tree node is no longer satisfied.

Clause 16: The method of any of clauses 11-15, further comprising: computing a second set of splitting features with a MAP for the second pre-trained model.

Clause 17: The method of any of clauses 11-16, further comprising: splitting a first binary feature dataset into multiple heads based on a random selection of dimensions from a first feature dataset to create a multi-head solution; determining a posterior probability of each point in each cluster included in each of the heads of the multi-head solution; evaluating a logarithm of each calculated posterior probability for each head and computing an average of all calculated logarithms as an average log posterior (ALP); and evaluating the ALP of each head.

Clause 18: The method of any of clauses 11-17, further comprising: splitting a second clustered binary feature dataset into multiple heads based on a random selection of dimensions from existing dimensions of the second feature dataset to create a multi-head solution; determining the posterior probability of each point in each cluster included in each of the heads of a second generated multi-head solution; evaluating a logarithm of each calculated posterior probability for each head and computing the average of all calculated logarithms as an ALP; and evaluating the ALP of each head.

Clause 19: The method of any of clauses 11-18, further comprising: comparing the two embedding datasets based on their respective average log posterior from each head of their respective multi-head solutions and splitting criteria of each embedding dataset, resulting in two quality metrics per embedding dataset.

Clause 20: The method of any of clauses 11-19, further comprising: selecting a model from at least the pre-trained model and the second pre-trained model based on comparing the metric for the pre-trained model to the metric for the second pre-trained model.

Clause 21: A computer program product comprising at least one non-transitory computer-readable medium including instructions that, when executed by at least one processor, cause the at least one processor to perform the method of any of clauses 11-20.

These and other features and characteristics of the present disclosure, as well as the methods of operation and functions of the related elements of structures and the combination of parts and economies of manufacture, will become more apparent upon consideration of the following description and the appended claims with reference to the accompanying drawings and appendix, all of which form a part of this specification, wherein like reference numerals designate corresponding parts in the various figures. It is to be expressly understood, however, that the drawings and appendix are for the purpose of illustration and description only and are not intended as a definition of the limits of the disclosed subject matter.

### BRIEF DESCRIPTION OF THE DRAWINGS

Additional advantages and details are explained in greater detail below with reference to the non-limiting, exemplary embodiments that are illustrated in the accompanying schematic figures and appendix, in which:

FIG. 1 is a schematic diagram of a system for multi-head posterior based pre-trained model evaluation, according to some non-limiting embodiments or aspects;

FIG. 2 is a flow diagram of a method for multi-head posterior based pre-trained model evaluation, according to some non-limiting embodiments or aspects;

FIG. 3 shows an electronic payment processing network according to some non-limiting embodiments or aspects; and

FIG. 4 is a schematic diagram of example components of one or more devices according to some non-limiting embodiments or aspects.

### DETAILED DESCRIPTION

For purposes of the description hereinafter, the terms “end,” “upper,” “lower,” “right,” “left,” “vertical,” “horizontal,” “top,” “bottom,” “lateral,” “longitudinal,” and derivatives thereof shall relate to the embodiments as they are oriented in the drawing figures. However, it is to be understood that the present disclosure may assume various alternative variations and step sequences, except where expressly specified to the contrary. It is also to be understood that the specific devices and processes illustrated in the attached drawings, and described in the following specification, are simply exemplary and non-limiting embodiments or aspects of the disclosed subject matter. Hence, specific dimensions and other physical characteristics related to the embodiments or aspects disclosed herein are not to be considered as limiting.

No aspect, component, element, structure, act, step, function, instruction, and/or the like used herein should be construed as critical or essential unless explicitly described as such. Also, as used herein, the articles “a” and “an” are intended to include one or more items and may be used interchangeably with “one or more” and “at least one.” Furthermore, as used herein, the term “set” is intended to include one or more items (e.g., related items, unrelated items, a combination of related and unrelated items, and/or the like) and may be used interchangeably with “one or more” or “at least one.” Where only one item is intended, the term “one” or similar language is used. Also, as used herein, the terms “has,” “have,” “having,” or the like are intended to be open-ended terms. Further, the phrase “based on” is intended to mean “based at least partially on” unless explicitly stated otherwise. In addition, reference to an action being “based on” a condition may refer to the action being “in response to” the condition. For example, the phrases “based on” and “in response to” may, in some non-limiting embodiments or aspects, refer to a condition for automatically triggering an action (e.g., a specific operation of an electronic device, such as a computing device, a processor, and/or the like).

As used herein, the term “communication” may refer to the reception, receipt, transmission, transfer, provision, and/or the like of data (e.g., information, signals, messages, instructions, commands, and/or the like). For one unit (e.g., a device, a system, a component of a device or system, combinations thereof, and/or the like) to be in communication with another unit means that the one unit is able to directly or indirectly receive information from and/or transmit information to the other unit. This may refer to a direct or indirect connection (e.g., a direct communication connection, an indirect communication connection, and/or the like) that is wired and/or wireless in nature. Additionally, two units may be in communication with each other even though the information transmitted may be modified, processed, relayed, and/or routed between the first and second unit. For example, a first unit may be in communication with a second unit even though the first unit passively receives information and does not actively transmit information to the second unit. As another example, a first unit may be in communication with a second unit if at least one intermediary unit processes information received from the first unit and communicates the processed information to the second unit. In some non-limiting embodiments or aspects, a message may refer to a network packet (e.g., a data packet and/or the like) that includes data. It will be appreciated that numerous other arrangements are possible.

As used herein, the term “computing device” may refer to one or more electronic devices configured to process data. A computing device may, in some examples, include the necessary components to receive, process, and output data, such as a processor, a display, a memory, an input device, a network interface, and/or the like. A computing device may be a mobile device. As an example, a mobile device may include a cellular phone (e.g., a smartphone or standard cellular phone), a portable computer, a wearable device (e.g., watches, glasses, lenses, clothing, and/or the like), a personal digital assistant (PDA), and/or other like devices. A computing device may also be a desktop computer or other form of non-mobile computer.

As used herein, the term “server” may refer to or include one or more computing devices that are operated by or facilitate communication and processing for multiple parties in a network environment, such as the Internet, although it will be appreciated that communication may be facilitated over one or more public or private network environments and that various other arrangements are possible. Further, multiple computing devices (e.g., servers, point-of-sale (POS) devices, mobile devices, etc.) directly or indirectly communicating in the network environment may constitute a “system.”

As used herein, the term “system” may refer to one or more computing devices or combinations of computing devices (e.g., processors, servers, client devices, software applications, components of such, and/or the like). Reference to “a device,” “a server,” “a processor,” and/or the like, as used herein, may refer to a previously-recited device, server, or processor that is recited as performing a previous step or function, a different device, server, or processor, and/or a combination of devices, servers, and/or processors. For example, as used in the specification and the claims, a first device, a first server, or a first processor that is recited as performing a first step or a first function may refer to the same or different device, server, or processor recited as performing a second step or a second function.

Non-limiting embodiments described herein provide a cost-efficient and time-efficient method by which pre-trained models, such as but not limited to language models, vision models, and/or the like, can be evaluated based on determining the consistency between entity embeddings and associated meta features. Non-limiting embodiments generate a metric (e.g., a performance metric) based on this determined consistency to improve and/or select a model. The systems, methods, and devices described herein provide improved results while also being more efficient than other methods of evaluating models. For example, evaluating a model based on downstream tasks requires repeated executions of the model for those downstream tasks and additional computational resources needed to analyze the results of those tasks.

Entity representations (e.g., embeddings) generated from machine-learning models can be utilized directly or indirectly by downstream tasks and can also be fine-tuned as needed. The meta features associated with these embeddings represent the foundational knowledge of the environment, such as but not limited to a class category for image data or semantic and syntactic information for words. Despite having the same meta features, embeddings differ across models. In non-limiting embodiments, the degree of consistency between the embeddings and meta features is used to generate a metric for evaluating and improving models.

In non-limiting embodiments, embeddings may be viewed as residing within a manifold space where Euclidean distance is not an appropriate metric for gauging the similarity between two embeddings. In non-limiting embodiments, meta features can be used to group these embeddings into clusters, each forming a sub-manifold space. By calculating the posterior probabilities of these embedding spaces in the form of Gaussian distributed clusters, the consistency of the meta features and embeddings can be calculated in non-limiting embodiments in a manner that does not require downstream testing. These metrics may be used to select a model out of a plurality of different models for implementing in a run-time environment. Through these unique features, non-limiting embodiments provide a tool to evaluate a model before it is deployed in a production environment and/or before it is tested with downstream tasks.

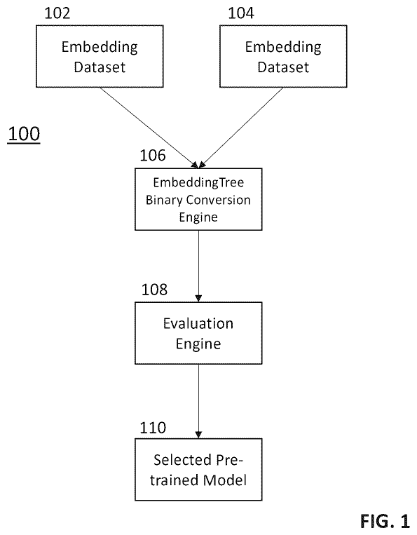

Referring now to FIG. 1, shown is the schematic diagram of a system for a multi-head posterior based approach for pre-trained model evaluation according to some non-limiting embodiments or aspects. As shown in FIG. 1, system 100 may include an embedding dataset 102, a different embedding dataset 104, a binary conversion engine 106, an evaluation engine 108, and a resulting selected pre-trained model 110. Embedding datasets 102 and 104 may be created from two different pre-trained Gaussian models, one of which is eventually selected as model 110. In some non-limiting embodiments, the binary conversion engine 106 and the evaluation engine 108 may be implemented in hardware, firmware, or a combination of hardware and software. The binary conversion engine 106 and evaluation engine 108 may be, for example, software functions and/or applications implemented and run on a device that may include a processor (e.g., a central processing unit (CPU), a graphics processing unit (GPU), an accelerated processing unit (APU), etc.), a microprocessor, a digital signal processor (DSP), and/or any processing component (e.g., a field-programmable gate array (FPGA), an application-specific integrated circuit (ASIC), etc.) that can be programmed to perform a function.

In non-limiting embodiments, the embedding datasets 102, 104 are generated based on two different pre-trained models and data relating to different entities (e.g., objects, media, people, companies, groups, and/or the like). The models may include Gaussian mixture models and/or any other type of pre-trained model (not shown in FIG. 1). Each of the embedding datasets 102, 104 may include a plurality of embeddings representing a plurality of entities. The binary conversion engine 106 may be configured to convert non-binary categorical features into binary features by applying yes-no queries to each categorical value to result in a binary feature set. The evaluation engine 108 may then receive the binary feature datasets resulting from each embedding dataset 102, 104 for processing. The evaluation engine 108 may cluster each entity of the plurality of entities represented by the embedding datasets 102, 104 based on the binary feature dataset (e.g., based on meta features of the embedding datasets 102, 104) for each corresponding dataset 102, 104, resulting in a plurality of clusters for each of the different models and corresponding datasets 102, 104.

With continued reference to FIG. 1, the evaluation engine 108 may then generate a metric for the pre-trained model corresponding to each dataset 102, 104 based on the posterior probability of each entity of the plurality of entities and the clusters. The posterior probability may represent the probability that an embedding for an entity belongs to a specific cluster in the embedding space. In non-limiting embodiments, the embedding space may be modeled as Gaussian distributions of the clusters. The posterior probability may be used to determine the consistency of the meta features and the embeddings in datasets 102, 104. The metric may be the posterior probability and/or a value derived from the posterior probabilities, such as an average log of the posterior probabilities. This metric reflects embedding quality as a difference between pre-trained models and embedding datasets 102, 104, utilizing the meta features as a source of foundational knowledge that is the same for each pre-trained model being evaluated.

In non-limiting embodiments, subsets of embedding dimensions may be randomly sampled and the results (e.g., metrics) averaged to provide a multi-head approach.

The number and arrangement of systems and devices shown in FIG. 1 are provided as an example. There may be additional systems and/or devices, fewer systems and/or devices, different systems and/or devices, and/or differently arranged systems and/or devices than those shown in FIG. 1. Furthermore, two or more systems or devices shown in FIG. 1 may be implemented within a single system or device, or a single system or device shown in FIG. 1 may be implemented as multiple, distributed systems or devices. Additionally, or alternatively, a set of systems (e.g., one or more systems) or a set of devices (e.g., one or more devices) of the system 100 may perform one or more functions described as being performed by another set of systems or another set of devices of the system 100.

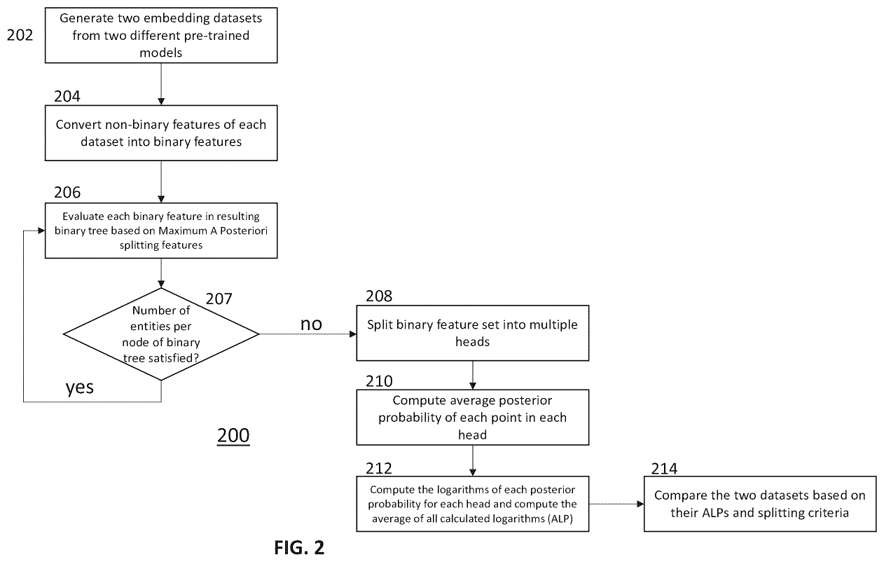

Referring now to FIG. 2 shown is a flow diagram 200 for a method for a multi-head posterior based approach for pre-trained model evaluation according to non-limiting embodiments or aspects. The steps shown in FIG. 2 are for example purposes only. It will be appreciated that additional, fewer, different, and/or a different order of steps may be used in some non-limiting embodiments or aspects. In some non-limiting embodiments or aspects, a step may be automatically performed in response to performance and/or completion of a prior step. At a first step 202, multiple (e.g., two or more) embedding datasets are created from different pre-trained models (e.g., such as but not limited to Gaussian mixture models).

For example, for a given domain, a large size of entities with rich meta features may be collected. Then for any given pretrained model, an embedding dataset denoted as X={x₁, . . . , xₙ} may be generated, where each xᵢ∈ [symbol] ^{d} and 1≤i≤N. In this representation, N represents the number of entities and d signifies the dimension of the embeddings. Simultaneously, a corresponding feature set F={f₁, . . . , fₙ} may be created. Each feature fᵢ may include both categorical and numerical features. The numerical features may be converted into categorical ones for consistency. The primary objective is to examine the consistency between these two datasets, X and F.

At a next step 204, each entity of the embedding set is clustered and subsequently converted into binary categorical features, creating two binary feature trees. In some non-limiting embodiments where the feature vector fᵢ includes only one feature, one approach to segmentation is to form clusters based only on these features. This approach capitalizes on the inherent characteristics of the data such that each unique category within the data forms its own distinct cluster, effectively grouping similar entities together. This approach may be extended as described herein to accommodate more than two meta features.

In non-limiting embodiments, a tree is constructed based on the entities and all the leaf nodes are the final clusters. This is done by first converting non-binary categorical features into binary ones by asking yes-no (e.g., binary) questions regarding each of the categorical values to get the binary feature sets: G={g₁, . . . , gₙ} where gᵢ∈{0,1}^{q}, 1≤i≤N, and q denotes the total number of converted binary features.

At steps 206-207, each feature of each binary feature tree is iteratively evaluated based on pre-computed Maximum A Posteriori splitting features. For example, with the processed data (e.g., converted binary features), the below algorithm may be executed to iterate and evaluate the features based on splitting criteria to select the best feature for splitting.

Algorithm 1 Build an EmbeddingTree

| | |
|---|---|
| 1: | procedure BUILDTREE([X, F], q, Θ) |
| 2: | if Θ is not satisfied then |
| 3: | return LeafNode([X, F]) |
| 4: | else |
| 5: | max_t ← −∞ |
| 6: | for k ∈ {1, ..., q} do |
| 7: | t = Embedding − MAP([X, F^{k}]) |
| 8: | if t > max_t then |
| 9: | bestFea = k |
| 10: | max_t = t |
| 11: | [X, F]_{left} = {x ∈ X\|F_{testFea} == 0} |
| 12: | |
| 13: | [X, F]_{right} = {x ∈ X\|F_{bestFea} == 1} |
| 14: | |
| 15: | Children.Left = BuildTree([X, F]_{left}, q, Θ) |
| 16: | Children.Right = BuildTree([X, F]_{right}, q, Θ) |
| 17: | return Children |

Line 6 of the algorithm iterates through q features, and the features are then evaluated based on the splitting criteria to select the best feature for splitting at lines 8-10 of the algorithm (using the binary value at lines 11-13). Steps 206-207 may be executed recursively (lines 15-16) until the splitting criterion Θ, e.g., the number of entities per tree node or the tree depth, is no longer satisfied (line 2). With the given embedding and feature data, the whole procedure is deterministic. In response to the number of entities per tree node or the tree depth being no longer satisfied, the method may proceed to step 208.

At step 208, the binary feature datasets may be randomly split in a multiple head manner. The splitting criteria S may be used divide the entities into a group of clusters C₁, C₂, . . . , Cₙ, with each entity belonging to a single cluster, where n is number of clusters. The criterion used to select the best splitting feature may be computed based on the approximate MAP for Gaussian Mixture Models (GMMs). The approach assumes the embedding can be modeled as two mixture Gaussians. The Expectation-Maximization (EM) algorithm may be used to jointly estimate all the parameters and latent variables. The latent variables zᵢⱼ denote the probability that sample i is in cluster j. With N as the number of observations and J as the number of Gaussian clusters (in this case, J=2), z={z_{1,1}, z_{1,2}, . . . , zₙⱼ₋₁, z_{n,j}}, the complete likelihood (including the latent variables) is:

$$P ( x , μ , Σ , w , z ) = {{\prod }^{N}}_{i = 1} {{\prod }^{J}}_{j = 1} {\{ {w}_{j} 𝒩 ( {x}_{a} ; {μ}_{j} , {Σ}_{j}^{2} ) \}}^{{z}_{ij}} ,$$

where μ is the mean vector and Σ is the covariance matrix of the Gaussians.

In non-limiting embodiments, every feature is analyzed to find the best binary feature that splits the embedding and forms the best GMM. Each candidate binary feature splits the embeddings into two clusters, and each cluster is then formulated as a Gaussian. For each feature, it may be configured such that the first s embeddings have feature value F^{k}=0 and the remaining N−s embeddings have feature value F^{k}=1. The weights, means, and variances may then each be estimated for both clusters using maximum likelihood estimation (MLE) as follows:

$$\begin{matrix}{\hat{μ}}_{1} = \frac{1}{s} {\sum }_{i = 1}^{s} {x}_{i} , & {\hat{Σ}}_{1} = \frac{1}{s} {\sum }_{i = 1}^{s} ( {x}_{i} - {\hat{μ}}_{1} ) {( {x}_{i} - {\hat{μ}}_{1} )}^{T} , & {\hat{w}}_{1} = \frac{s}{N} , \\ {\hat{μ}}_{2} = \frac{1}{N - s} {\sum }_{i = s + 1}^{N} {x}_{i} , & {\hat{Σ}}_{2} = \frac{1}{N - s} {\sum }_{i = s + 1}^{N} ( {x}_{i} - {\hat{μ}}_{2} ) {( {x}_{i} - {\hat{μ}}_{2} )}^{T} , & {\hat{w}}_{2} = \frac{N - s}{N} .\end{matrix}$$

The algorithm performs a hard clustering rather than the soft clustering provided by GMM. Thus, if xᵢ is in cluster j, then z_{i,j}=1 and z_{i,j}′=0 for all j≠j′. Given this approximation, the likelihood can be obtained by summing over z.

$$P ( x , μ , Σ , w ) = {\sum }_{z} {{\prod }^{N}}_{i = 1} {{\prod }^{J}}_{j = 1} {\{ {w}_{j} 𝒩 ( {x}_{a} ; {μ}_{j} , {Σ}_{j}^{2} ) \}}^{{z}_{ij}}$$

In the above, z_{(i∈(0, s], j=1)}=z_{(i∈[s+1, N), j=2)}=1 and z_{i,j}=0, otherwise the above equation simplifies to:

$$P ( x , μ , Σ , w ) = {{\prod }^{s}}_{i = 1} {w}_{1} 𝒩 ( {x}_{i} ; {μ}_{1} , {Σ}_{1}^{2} ) {{\prod }^{N}}_{i = s + 1} {w}_{2} 𝒩 ( {x}_{i} ; {μ}_{2} , {Σ}_{2}^{2} ) .$$

In non-limiting embodiments, each split feature may be treated as another random variable θ. To choose the best split feature, the value of P(x, μ, Σ, w, θ) is maximized. The value of θ is identified that produces the largest P(x, μ, Σ, w).

In non-limiting embodiments, θ may be considered as the random variable to estimate. By injecting the prior information into the formula, each splitting feature may be treated with a different weight. By applying Maximum A Posteriori Estimation (MAP), the problem may be formulated as follows:

$$P ( {θ}_{i} \vert x ) = \frac{P ( x \vert {θ}_{i} ) P ( {θ}_{i} )}{{\sum }_{j = 1}^{q} P ( x \vert {θ}_{j} ) P ( {θ}_{j} )} ,$$

where q is the number of possible splits. By combining equations, the following is provided:

$$P ( {θ}_{i} \vert x ) = \frac{{\prod }_{k = 1}^{s} {w}_{1} 𝒩 ( {x}_{k} ; {μ}_{1} , {Σ}_{1}^{2} , {θ}_{i} ) {\prod }_{k = s + 1}^{N} {w}_{2} 𝒩 ( {x}_{k} ; {μ}_{2} , {Σ}_{2}^{2} , {θ}_{i} ) p ( {θ}_{i} )}{{\sum }_{j = 1}^{q} {\prod }_{k = 1}^{s} {w}_{1} 𝒩 ( {x}_{k} ; {μ}_{1} , {Σ}_{1}^{2} , {θ}_{j} ) {\prod }_{k = s + 1}^{N} {w}_{2} 𝒩 ( {x}_{k} ; {μ}_{2} , {Σ}_{2}^{2} , {θ}_{j} ) p ( {θ}_{j} )} .$$

Plugging in the estimates for all the parameters and taking the logarithm of P(θᵢ|x), the following is obtained:

$$log \hat{P} ( {θ}_{i} \vert x ) = {\sum }_{i = 1}^{s} [ log {\hat{w}}_{1} + log 𝒩 ( {x}_{i} ; {\hat{μ}}_{1} , {\hat{Σ}}_{1}^{2} ) ] + {\sum }_{i = s + 1}^{N} [ log {\hat{w}}_{2} + log 𝒩 ( {x}_{i} ; {\hat{μ}}_{2} , {\hat{Σ}}_{2}^{2} ) ] + log p ( {θ}_{i} ) - log ( {\sum }_{j = 1}^{q} {\sum }_{k = 1}^{s} {w}_{1} 𝒩 ( {x}_{k} ; {\hat{μ}}_{1} , {\hat{Σ}}_{1}^{2} , {θ}_{j} ) {\sum }_{k = s + 1}^{N} {w}_{2} 𝒩 ( {x}_{k} ; {\hat{μ}}_{2} , {\hat{Σ}}_{2}^{2} , {θ}_{j} ) p ( {θ}_{j} ) ) .$$

By applying this formula, the prior knowledge is applied on the importance of the feature to find the split that maximizes log \hat{P}.

In non-limiting embodiments with two sets of embeddings, X_{A}={x_{A1}, . . . , x_{An}} and X_{B}={x_{B1}, . . . , x_{Bn}}, both trained on the same dataset but using different models, denoted as models A and B, where x_{Ai}, x_{Bi}∈ [symbol] ^{p}, 1≤i≤N, two corresponding splitting criteria may be generated, S_{A} and S_{B}. The objective is to assess and compare the quality of these two sets of embeddings. ALP^{xA}_{S}_{^{A}} may be represented as ALP^{AA} for embeddings X_{A} and splitting criteria S_{A}. Given two sets of embeddings, X_{A} and X_{B}, along with two corresponding splitting criteria, S_{A} and S_{B}, four metrics may be defined:

$$A L {P}_{A}^{A}$$

(embeddings X_{A} with splitting criteria S_{A})

$$A L {P}_{B}^{B}$$

(embeddings X_{B} with splitting criteria S_{B})

$$A L {P}_{A}^{B}$$

(embeddings X_{B} with splitting criteria S_{A})

$$A L {P}_{B}^{A}$$

(embeddings X_{A} with splitting criteria S_{B})

The splitting criteria may be fixed to perform clustering, so a proper comparison may be between

$$A L {P}_{A}^{A} and {ALP}_{A}^{B} ,$$

or between

$$A L {P}_{B}^{A} and {ALP}_{B}^{B} .$$

At step 210, the average posterior probability of each head may be calculated. In this step, the quality of each cluster is determined with a posterior based approach. In the context of a GMM, it is assumed that the data is generated from a combination of multiple Gaussian distributions. Each component of this mixture corresponds to one of the distinct clusters within the dataset. For any given data point within a particular cluster, the formula for calculating its posterior probability in the GMM framework can be expressed as follows:

$$P ( θ = k \vert {x}_{k} ) = \frac{P ( {x}_{k} \vert θ = k ) P ( θ = k )}{{\sum }_{j = 1}^{m} P ( {x}_{k} \vert θ = j ) P ( θ = j )} ,$$

where xₖ represents every point in cluster k. To assess the quality of embeddings X within the context of a splitting S, the overall evaluation metric P^{x}ₛ is computed by averaging the log probabilities of all the embeddings across all clusters. This metric provides an assessment of the quality of the embeddings. This may be referred to as the average of log posterior:

$${ALP}_{S}^{X} = \frac{1}{N} {\sum }_{k = 1}^{m} {\sum }_{{x}_{1} ∈ {C}_{k}}^{} log P ( θ = k \vert {x}_{i} )$$

This formula may be sensitive to outliers such that a single outlier could lead to an extremely large value for

$${P}_{S}^{X} .$$

To mitigate the impact of such outlier entities, in non-limiting embodiments a clipping mechanism is implemented for embeddings with very small posterior probabilities. Specifically, if P(θ=k|xₖ) is less than (k/N)*ε, the entity (e.g., associated embedding(s)) may be excluded from the

$${P}_{S}^{X}$$

computation.

When the embeddings exist in large dimensions, if the number of embeddings in each cluster is smaller than the embedding dimension, a rank-deficient covariance may result. To address this, v dimensions are randomly selected and evaluated based on these dimensions. This process is repeated multiple times and the average results are used. Additionally, the routine regularization approach, e.g., adding ε/to the covariance matrix, may be applied. The value of ε is decided in the following manner:

$$ϵ = max ( {λ}_{k} / ( 10 D ) {λ}_{0} , 1 e - 8 ) ,$$

where D is the dimensionality of the embeddings and λᵢ are the eigenvalues of the covariance matrix (sorted decreasingly by their magnitude). k is the minimum value that satisfies:

$$\frac{{Σ}_{i = 0}^{k} {λ}_{i}}{{Σ}_{i = 0}^{D} {λ}_{i}} > 99.99 \% .$$

At step 212, the logarithms of each of these average posterior probabilities are taken and averaged together to obtain the averages of all computed logarithms for each embedding set. At step 214, the averages of all calculated logarithms and the splitting criteria of each embedding set are compared to subsequently determine the metrics by which each embedding set can be evaluated.

In non-limiting embodiments, embeddings may be measured by inputting different datasets into models and obtaining the activations/embeddings at each layer of the models. Multiple sets of embeddings may be obtained in this manner from each model and processed according to the above-described method to compute the posterior probability metric. In this manner, the quality of embeddings may be measured across multiple datasets and models.

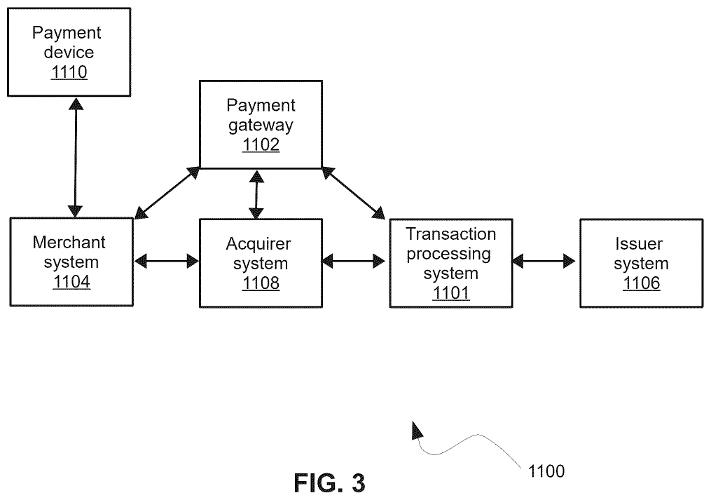

FIG. 3 shows an electronic payment processing network 1100 according to some non-limiting embodiments or aspects. The payment processing network 1100 may be used in conjunction with the systems and methods described herein. It will be appreciated that the particular arrangement of the electronic payment processing network 1100 shown is for example purposes only, and that various arrangements are possible. A transaction processing system 1101 (e.g., a transaction handler) is shown to be in communication with one or more issuer systems (e.g., such as an issuer system 1106) and one or more acquirer systems (e.g., such as an acquirer system 1108). Although only a single issuer system 1106 and single acquirer system 1108 are shown, it will be appreciated that the transaction processing system 1101 may be in communication with a plurality of issuer systems and/or acquirer systems. In some embodiments, the transaction processing system 1101 may also operate as an issuer system such that both the transaction processing system 1101 and issuer system 1106 are a single system and/or controlled by a single entity.

In some non-limiting embodiments or aspects, the transaction processing system 1101 may communicate with a merchant system 1104 directly through a public or private network connection. Additionally, or alternatively, the transaction processing system 1101 may communicate with the merchant system 1104 through a payment gateway 1102 and/or the acquirer system 1108. In some non-limiting embodiments or aspects, the acquirer system 1108 associated with the merchant system 1104 may operate as the payment gateway 1102 to facilitate the communication of transaction requests from the merchant system 1104 to the transaction processing system 1101. The merchant system 1104 may communicate with the payment gateway 1102 through a public or private network connection. For example, a merchant system 1104 that includes a physical POS device may communicate with the payment gateway 1102 through a public or private network to conduct card-present transactions. As another example, a merchant system 1104 that includes a server (e.g., a web server) may communicate with the payment gateway 1102 through a public or private network, such as a public Internet connection, to conduct card-not-present transactions.

In some non-limiting embodiments or aspects, the transaction processing system 1101, after receiving a transaction request from the merchant system 1104 that identifies an account identifier of a payor (e.g., such as an account holder) associated with an issued payment device 1110, may generate an authorization request message to be communicated to the issuer system 1106 that issued the payment device 1110 and/or account identifier. The issuer system 1106 may then approve or decline the authorization request and, based on the approval or denial, generate an authorization response message that is communicated to the transaction processing system 1101. The transaction processing system 1101 may communicate an approval or denial to the merchant system 1104. When the issuer system 1106 approves the authorization request message, it may then clear and settle the payment transaction between the issuer system 1106 and acquirer system 1108.

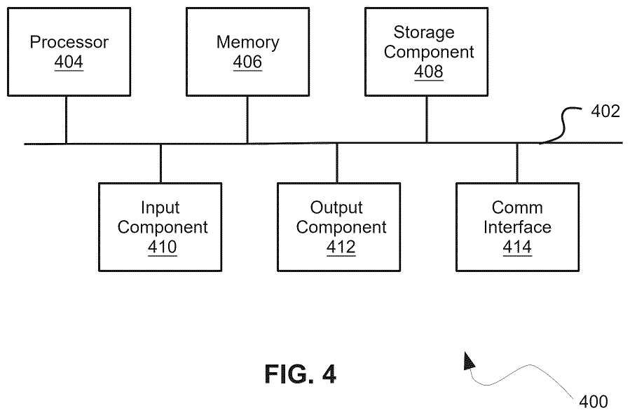

Referring now to FIG. 4, shown is a diagram of example components of a device 400 according to non-limiting embodiments or aspects. Device 400 may correspond to the binary conversion engine 106, evaluation engine 108, and/or other system components shown and described in connection with FIG. 1. In non-limiting embodiments or aspects, such systems or devices may include at least one device 400 and/or at least one component of device 400. The number and arrangement of components shown in FIG. 3 are provided as an example. In non-limiting embodiments or aspects, device 400 may include additional components, fewer components, different components, or differently arranged components than those shown. Additionally, or alternatively, a set of components (e.g., one or more components) of device 400 may perform one or more functions described as being performed by another set of components of device 400.

Device 400 may include bus 402, processor 404, memory 406, storage component 408, input component 410, output component 412, and communication interface 414. Bus 402 may include a component that permits communication among the components of device 400. In non-limiting embodiments or aspects, processor 404 may be implemented in hardware, firmware, or a combination of hardware and software. For example, processor 404 may include a processor (e.g., a central processing unit (CPU), a graphics processing unit (GPU), an accelerated processing unit (APU), etc.), a microprocessor, a digital signal processor (DSP), and/or any processing component (e.g., a field-programmable gate array (FPGA), an application-specific integrated circuit (ASIC), etc.) that can be programmed to perform a function. Memory 406 may include random access memory (RAM), read only memory (ROM), and/or another type of dynamic or static storage device (e.g., flash memory, magnetic memory, optical memory, etc.) that stores information and/or instructions for use by processor 404.

Storage component 408 may store information and/or software related to the operation and use of device 400. For example, storage component 408 may include a hard disk (e.g., a magnetic disk, an optical disk, a magneto-optic disk, a solid state disk, etc.) and/or another type of computer-readable medium. Input component 410 may include a component that permits device 400 to receive information, such as via user input (e.g., a touch screen display, a keyboard, a keypad, a mouse, a button, a switch, a microphone, etc.). Additionally, or alternatively, input component 410 may include a sensor for sensing information (e.g., a global positioning system (GPS) component, an accelerometer, a gyroscope, an actuator, etc.). Output component 412 may include a component that provides output information from device 400 (e.g., a display, a speaker, one or more light-emitting diodes (LEDs), etc.). Communication interface 414 may include a transceiver-like component (e.g., a transceiver, a separate receiver and transmitter, etc.) that enables device 400 to communicate with other devices, such as via a wired connection, a wireless connection, or a combination of wired and wireless connections. Communication interface 414 may permit device 400 to receive information from another device and/or provide information to another device. For example, communication interface 414 may include an Ethernet interface, an optical interface, a coaxial interface, an infrared interface, a radio frequency (RF) interface, a universal serial bus (USB) interface, a Wi-Fi® interface, a cellular network interface, and/or the like.

Device 400 may perform one or more processes described herein. Device 400 may perform these processes based on processor 404 executing software instructions stored by a computer-readable medium, such as memory 406 and/or storage component 408. A computer-readable medium may include any non-transitory memory device. A memory device includes memory space located inside of a single physical storage device or memory space spread across multiple physical storage devices. Software instructions may be read into memory 406 and/or storage component 408 from another computer-readable medium or from another device via communication interface 414. When executed, software instructions stored in memory 406 and/or storage component 408 may cause processor 404 to perform one or more processes described herein. Additionally, or alternatively, hardwired circuitry may be used in place of or in combination with software instructions to perform one or more processes described herein. Thus, embodiments described herein are not limited to any specific combination of hardware circuitry and software. The term “configured to,” as used herein, may refer to an arrangement of software, device(s), and/or hardware for performing and/or enabling one or more functions (e.g., actions, processes, steps of a process, and/or the like). For example, “a processor configured to” may refer to a processor that executes software instructions (e.g., program code) that cause the processor to perform one or more functions.

Although embodiments have been described in detail for the purpose of illustration, it is to be understood that such detail is solely for that purpose and that the disclosure is not limited to the disclosed embodiments or aspects, but, on the contrary, is intended to cover modifications and equivalent arrangements that are within the spirit and scope of the appended claims. For example, it is to be understood that the present disclosure contemplates that, to the extent possible, one or more features of any embodiment or aspect can be combined with one or more features of any other embodiment or aspect.

What is claimed is:

1. A system comprising:
at least one processor configured to:
generate an embedding dataset based on a pre-trained model, the embedding dataset comprising a plurality of embeddings representing a plurality of entities;
cluster each entity of the plurality of entities based on a feature dataset, resulting in a plurality of clusters; and
generate a metric for the pre-trained model based on a posterior probability of each entity of the plurality of entities and the plurality of clusters.

2. The system of claim 1, wherein the at least one processor is further configured to:
generate a second embedding dataset based on a second pre-trained model, the second embedding dataset comprising a second plurality of embeddings representing the plurality of entities;
cluster each entity of the plurality of entities based on a second feature dataset, resulting in a second plurality of clusters; and
determine a metric for the second pre-trained model based on the posterior probability of each embedding of the second plurality of embeddings for the second plurality of clusters.

3. The system of claim 1, wherein the at least one processor is further configured to:
convert non-binary categorical features of the feature dataset into binary features, resulting in a binary tree comprising a binary feature dataset; and
evaluate each of the features in the binary feature dataset based on splitting features until a number of entities per node of a binary tree node is no longer satisfied.

4. The system of claim 1, wherein the at least one processor is further configured to:
compute a first set of splitting features with a Maximum A Posteriori (MAP) for a first pre-trained model.

5. The system of claim 2, wherein the at least one processor is further configured to:
convert non-binary categorical features of the second feature dataset into binary features, resulting in a second binary feature dataset in a form of a binary tree; and
evaluate each of the features in the resulting second binary feature dataset based on splitting features until a number of entities per tree node is no longer satisfied.

6. The system of claim 2, wherein the at least one processor is further configured to:
compute a second set of splitting features with a MAP for the second pre-trained model.

7. The system of claim 1, wherein the at least one processor is further configured to:
split a first binary feature dataset into multiple heads based on a random selection of dimensions from the first feature dataset to create a multi-head solution;
determine a posterior probability of each point in each cluster included in each of the heads of the multi-head solution;
evaluate the logarithm of each calculated posterior probability for each head and computing the average of all calculated logarithms as an average log posterior (ALP); and
evaluate the ALP of each head.

8. The system of claim 2, wherein the at least one processor is further configured to:
split a second clustered binary feature dataset into multiple heads based on a random selection of dimensions from existing dimensions of the second feature dataset to create a multi-head solution;
determine the posterior probability of each point in each cluster included in each of the heads of a second generated multi-head solution;
evaluate a logarithm of each calculated posterior probability for each head and computing an average of all calculated logarithms as an ALP; and
evaluate the ALP of each head.

9. The system of claim 2, wherein the at least one processor is further configured to:
compare two embedding datasets based on their respective average of all calculated logarithms from each head of their respective multi-head solutions and splitting criteria of each embedding dataset, resulting in two quality metrics per embedding dataset.

10. The system of claim 2, wherein the at least one processor is further configured to:
select a model from at least the pre-trained model and the second pre-trained model based on comparing the metric for the pre-trained model to the metric for the second pre-trained model.

11. A method comprising:
generating an embedding dataset based on a pre-trained model, the embedding dataset comprising a plurality of embeddings representing a plurality of entities;
clustering each entity of the plurality of entities based on a feature dataset, resulting in a plurality of clusters; and
generating a metric for the pre-trained model based on a posterior probability of each entity of the plurality of entities and the plurality of clusters.

12. The method of claim 11, further comprising:
generating a second embedding dataset based on a second pre-trained model, the second embedding dataset comprising a second plurality of embeddings representing the plurality of entities;
clustering each entity of the plurality of entities based on a second feature dataset, resulting in a second plurality of clusters; and
determining a metric for the second pre-trained model based on the posterior probability of each embedding of the second plurality of embeddings for the second plurality of clusters.

13. The method of claim 11, further comprising:
converting non-binary categorical features of the feature dataset into binary features, resulting in a binary tree comprising a binary feature dataset; and
evaluating each of the features in the binary feature dataset based on splitting features until a number of entities per node of a binary tree node is no longer satisfied.

14. The method of claim 11, further comprising:
computing a first set of splitting features with a Maximum A Posteriori (MAP) for a first pre-trained model.

15. The method of claim 12, further comprising:
converting non-binary categorical features of the second feature dataset into binary features, resulting in a second binary feature dataset in a form of a binary tree; and
evaluating each of the features in the resulting second binary feature dataset based on splitting features until a number of entities per tree node is no longer satisfied.

16. The method of claim 12, further comprising:
computing a second set of splitting features with a MAP for the second pre-trained model.

17. The method of claim 11, further comprising:
splitting a first binary feature dataset into multiple heads based on a random selection of dimensions from a first feature dataset to create a multi-head solution;
determining a posterior probability of each point in each cluster included in each of the heads of the multi-head solution;
evaluating a logarithm of each calculated posterior probability for each head and computing an average of all calculated logarithms as an average log posterior (ALP); and
evaluating the ALP of each head.

18. The method of claim 12, further comprising:
splitting a second clustered binary feature dataset into multiple heads based on a random selection of dimensions from existing dimensions of the second feature dataset to create a multi-head solution;
determining the posterior probability of each point in each cluster included in each of the heads of a second generated multi-head solution;
evaluating a logarithm of each calculated posterior probability for each head and computing the average of all calculated logarithms as an ALP; and
evaluating the ALP of each head.

19. The method of claim 12, further comprising:
comparing the two embedding datasets based on their respective average log posterior from each head of their respective multi-head solutions and splitting criteria of each embedding dataset, resulting in two quality metrics per embedding dataset.

20. A computer program product comprising at least one non-transitory computer-readable medium including instructions that, when executed by at least one processor, cause the at least one processor to:
generate an embedding dataset based on a pre-trained model, the embedding dataset comprising a plurality of embeddings representing a plurality of entities;
cluster each entity of the plurality of entities based on a feature dataset, resulting in a plurality of clusters; and
generate a metric for the pre-trained model based on a posterior probability of each entity of the plurality of entities and the plurality of clusters.
